(19) United States
(12) Patent Application Publication
(10) Pub. No.: US 2017/0023055 A1
(43) Pub. Date: Jan. 26, 2017

(54) BALL JOINT, A BALL JOINT MANUFACTURING APPARATUS AND A METHOD OF MANUFACTURING A BALL JOINT

(71) Applicant: PRIMAX CORPORATION, Wonju-si (KR)

(72) Inventor: Kwan Soo LEE, Daegu (KR)

(73) Assignee: PRIMAX CORPORATION, Wonju-si (KR)

(21) Appl. No.: 15/215,408

(22) Filed: Jul. 20, 2016

(30) Foreign Application Priority Data
Jul. 21, 2015 (KR) 10-2015-0102892

(51) Int. Cl. F16C 11/06

(52) U.S. Cl. CPC F16C 11/068; F16C 11/0623; F16C 11/0685

(57) ABSTRACT

The present invention relates to a ball joint used in a steering system, an apparatus for manufacturing the ball joint, and a method of manufacturing the ball joint and includes a ball stud provided with a stud and a ball formed at one end of the stud, a housing which accommodates the ball to pivotally support the ball stud and is provided with an injection hole into which a lubricant and a base material are injectable, a ball seat formed in a separation space between the ball and the housing, and an injection hole closing portion inserted into the injection hole to close the injection hole, wherein the ball is provided with a dent portion formed by denting the surface to store the lubricant and to mitigate surface pressure between the ball and the ball seat.

### CROSS-REFERENCE TO RELATED APPLICATION

This application claims priority to and the benefit of Korean Patent Application No. 10-2015-0102892, filed on Jul. 21, 2015, the disclosure of which is incorporated herein by reference in its entirety.

### BACKGROUND

1. Field of the Invention

The present invention relates to a ball joint used in a steering system, an apparatus for manufacturing the ball joint, and a method of manufacturing the ball joint, and more particularly, to a ball joint in which a ball of a ball stud performs a pivot movement in a ball housing, an apparatus for manufacturing the ball joint, and a method of manufacturing the ball joint.

2. Discussion of Related Art

The present invention relates to a ball joint, an apparatus for manufacturing the ball joint, and a method of manufacturing the ball joint, and more particularly, to a ball joint in which a ball of a ball stud performs a pivot movement in a ball seat, an apparatus for manufacturing the ball joint, and a method of manufacturing the ball joint.

A ball joint is applied to various industrial fields including a steering system, a suspension system, etc. of a vehicle.

A conventional ball joint includes a ball stud provided with a ball, a ball seat, a housing, and a dust cover.

To simplify a process of manufacturing such a ball joint, a method of integrally forming the ball seat by injection-molding the ball seat by injecting a base material of a synthetic resin between the ball of the ball stud and the housing is widely known.

A through hole into which a base material can be injected is formed in the housing for injecting the base material between the ball and the housing, and a plug is additionally installed in the housing to block the through hole after injecting the base material and injection-molding the ball seat.

As in the conventional case, for installing the plug in the housing, a coupling element that allows installing a plug in the housing is additionally required, and a problem occurs where the plug separates from the housing when the coupling element is weakened.

In addition, although there is a method of injecting a lubricant between the ball and the ball seat to mitigate surface pressure between the ball and the ball seat, a dent portion in which a lubricant can be stored needs to be additionally provided in the ball seat to increase lubricating effect.

Additional processes are needed to provide the dent portion that result in an increased defect rate of the ball seat, and, as a result, a problem arises where manufacturability of the ball joint is lowered.

### SUMMARY OF THE INVENTION

The present invention is directed to providing a ball joint, an apparatus for manufacturing the ball joint, and a method of manufacturing the ball joint, and more particularly, to providing an excellent ball joint, an apparatus for manufacturing the ball joint, and a method of manufacturing the ball joint, which are capable of effectively closing an injection hole provided in a housing for integrally injection-molding a ball seat, mitigating surface pressure between a ball and the ball seat, and increasing lubricating effect.

According to an aspect of the present invention, there is provided a ball joint used in a steering system, which includes a ball stud having a stud and a ball formed at one end of the stud, a housing which accommodates the ball to pivotably support the ball stud and has an injection hole into which a lubricant and a base material are injectable, a ball seat injection-molded by the base material injected into a separation space between the ball and the housing via the injection hole, and an injection hole closing portion inserted into the injection hole to close the injection hole, wherein the ball has a dent portion formed by denting the surface to store the lubricant and to mitigate surface pressure between the ball and the ball seat.

The injection hole closing portion of the ball joint may have a feature that a perimeter of the top surface, which is first inserted into the injection hole to guide the insertion into the injection hole, smaller than a perimeter of a bottom surface.

The injection hole closing portion of the ball joint may include an installation portion formed to protrude or dent from a bottom surface which is last inserted into the injection hole so that an external device for inserting the injection hole closing portion into the injection hole is installed.

The injection hole closing portion of the ball joint may have a bottom surface which is last inserted into the injection hole is positioned at the same level as an entrance of the injection hole to prevent the injection hole closing portion from being separated from the injection hole.

The ball seat of the ball joint may include a contact portion in contact with the ball, and an extension portion formed to extend from the contact portion and positioned on the injection hole. Further, the injection hole closing portion may be in contact with the extension portion and inserted into the injection hole to prevent being separated from the injection hole.

The injection hole closing portion of the ball joint may be pressed and inserted into the injection hole so that the lubricant stored in the dent portion moves between the ball and the ball seat.

The dent portion of the ball joint may be formed to face the injection hole to store the lubricant injected via the injection hole.

The dent portion of the ball joint may have a shape having a narrower upper portion and a wider lower portion to store the lubricant injected via the injection hole.

According to another aspect of the present invention, there is provided a ball joint manufacturing apparatus for manufacturing a ball joint including an upper mold, a lower mold which provides a space in which a housing that accommodates a ball stud is disposed by being coupled to the upper mold and has a base material injection portion formed to pass therethrough so that a base material for forming a ball seat is injected into a separation space between the ball stud and the housing, and an insertion portion inserted into the base material injection portion and having an injection space which provides an injection channel of the base material so that the base material is uniformly injected into the entire separation space, wherein the insertion portion further has an inflow prevention portion inserted into a dent portion formed by denting the surface of the ball to prevent the base material from being introduced into the dent portion so that the lubricant is stored in the ball stud.

The insertion portion of the ball joint manufacturing apparatus for manufacturing the ball joint may further include an injection portion which forms the injection space into which the base material is injected from the outside and an injection extension portion formed to extend from the injection portion and configured to form the injection space, wherein the injection extension portion may have a width smaller than a width of an injection hole to form a ball seat on the injection hole formed to pass through the housing for the base material to be injected into the separation space between the ball stud and the housing.

The injection space of the ball joint manufacturing apparatus for manufacturing the ball joint may include an introduction space which provides a space for the base material to be injected from the outside, and a backflow prevention space formed to have a size smaller than the introduction space to prevent the base material injected into the separation space between the ball stud and the housing from flowing backward.

According to still another aspect of the present invention, there is provided a method of manufacturing a ball joint by injection-molding a ball seat between a ball stud, which includes a ball and a housing, including a first operation in which the ball stud and the housing are disposed at predetermined positions of an injection mold, a second operation in which an insertion portion which provides a channel through which a base material is injected is disposed in the housing so that the ball seat is injection-molded in the separation space between the ball stud and the housing, a third operation in which the base material is injected into the separation space via the insertion portion, a fourth operation in which the insertion portion is removed and a lubricant is injected into the space in which the insertion portion is removed, and a fifth operation in which an injection hole closing portion is pressurized and inserted into the space in which the insertion portion is removed so that a lubricant moves between the ball and the ball seat.

The third operation of the method of manufacturing a ball joint may include injecting the base material into the separation space via the insertion portion which includes an inflow prevention portion inserted into a dent portion and preventing the base material from being introduced into the dent portion formed by denting the surface of the ball.

The fourth operation of the method of manufacturing a ball joint may include injecting the lubricant into the dent portion formed by denting the surface of the ball.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic cross-sectional view illustrating a ball joint according to one embodiment of the present invention;

FIG. 2 is a schematic cross-sectional view illustrating a housing of the ball joint according to one embodiment of the present invention;

FIGS. 3A to 3C are a schematic perspective view and schematic cross-sectional views illustrating an injection hole closing portion of the ball joint according to one embodiment of the present invention;

FIGS. 4A and 4B are a schematic perspective view and a schematic cross-sectional view illustrating a ball stud of the ball joint according to one embodiment of the present invention;

FIGS. 5 and 6 are schematic cross-sectional views illustrating an apparatus for manufacturing the ball joint according to one embodiment of the present invention;

FIGS. 7A and 7B are a schematic perspective view and a schematic cross-sectional view illustrating an insertion portion of the apparatus for manufacturing the ball joint according to one embodiment of the present invention; and

FIGS. 8 to 10 are schematic cross-sectional views sequentially illustrating a method of manufacturing the ball joint according to one embodiment of the present invention.

### DETAILED DESCRIPTION OF EXEMPLARY EMBODIMENTS

Hereinafter, exemplar embodiments of the present invention will be described in detail with reference to the accompanying drawings. However, the inventive concept of the present invention is not limited to the embodiments set forth herein, and it should be noted that those skilled in the art who understand the inventive concept may easily propose other embodiments within the scope of other lesser inventive inventions or the inventive concept of the present invention by adding, modifying, and eliminating components within the scope of the same idea, which are also construed as falling within the scope of the inventive concept of the present invention.

In addition, components with the same function within the same inventive concept shown in the drawings of each embodiment are described using the same reference numerals.

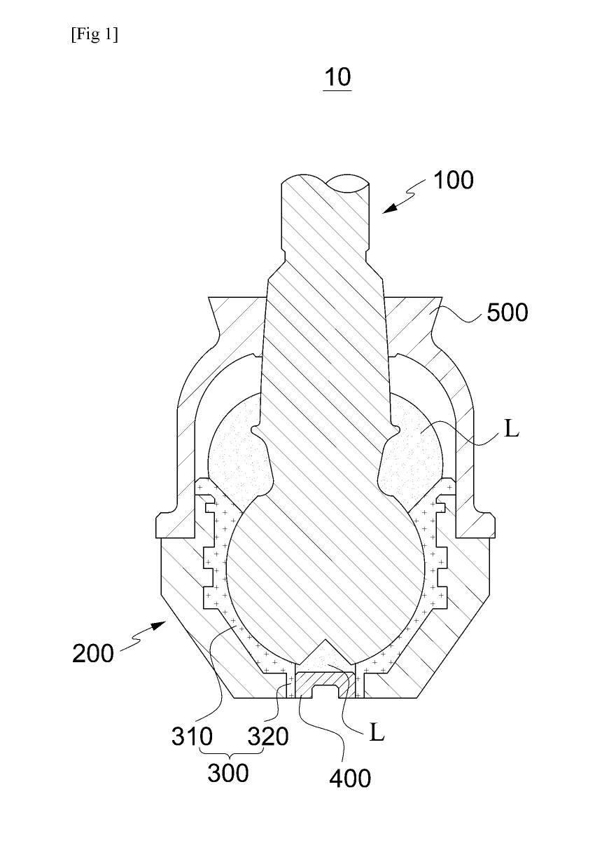

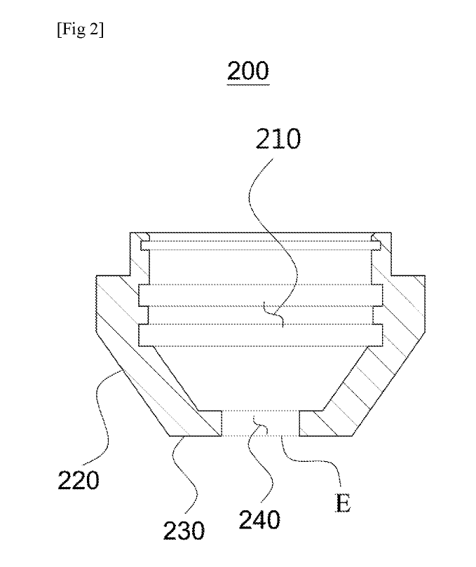

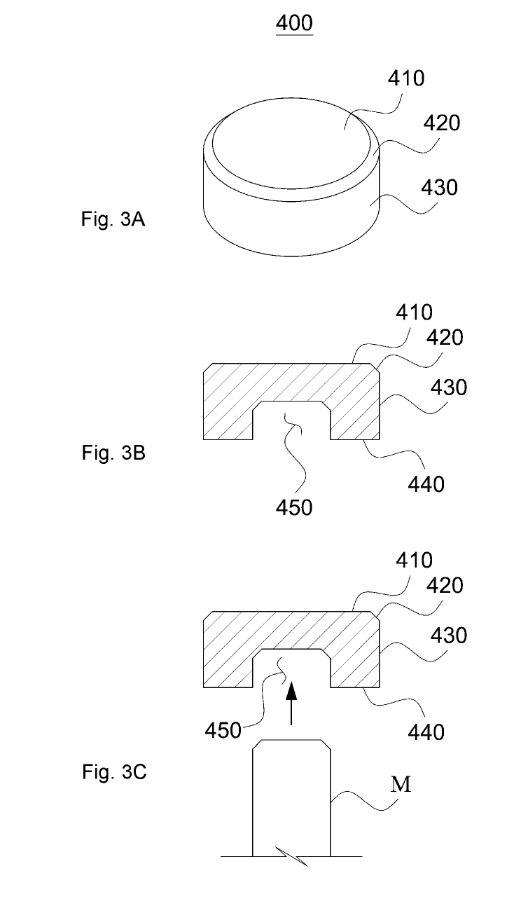

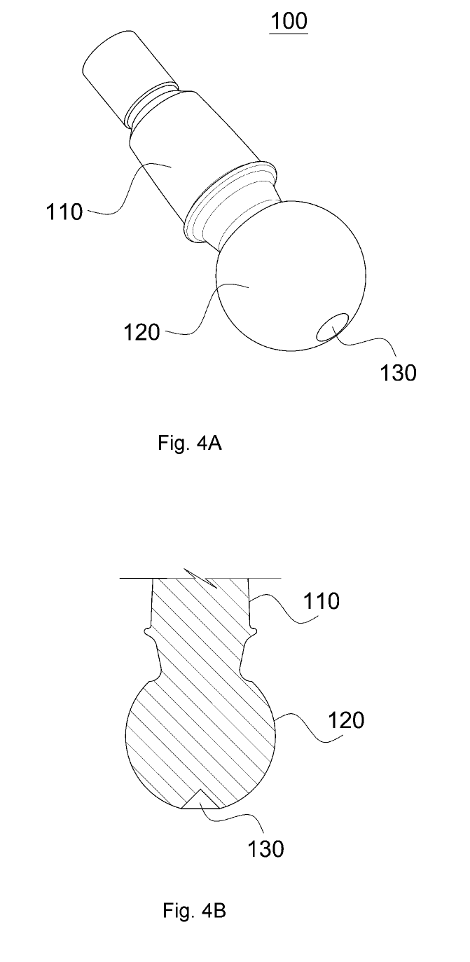

FIG. 1 is a schematic cross-sectional view illustrating a ball joint according to one embodiment of the present invention, FIG. 2 is a schematic cross-sectional view illustrating a housing of the ball joint according to one embodiment of the present invention, FIGS. 3A to 3C are a schematic perspective view and schematic cross-sectional views illustrating an injection hole closing portion of the ball joint according to one embodiment of the present invention, and FIGS. 4A and 4B are a schematic perspective view and a schematic cross-sectional view illustrating a ball stud of the ball joint according to one embodiment of the present invention.

As illustrated in FIGS. 1 to 4, a ball joint 10 according to one embodiment of the present invention may include a stud 110, a ball stud 100 provided with a ball 120 formed at one end of the stud 110, a housing 200 which accommodates the ball 120 to pivotally support the ball stud 100 and includes an injection hole 240 through which a lubricant L and a base material B may be injected, a ball seat 300 injection-molded by introducing the base material B into a separation space K between the ball 120 and the housing 200 via the injection hole 240, an injection hole closing portion 400 inserted into the injection hole 240 to close the injection hole 240, and a dust cover 500 which prevents foreign substances from being introduced into the ball 120 and the ball seat 300.

The housing 200 may be provided with an accommodating space 210 which may accommodate the ball 120 and may include a side wall portion 220 and a bottom portion 230 formed extending from the side wall portion 220 to form the accommodating space 210.

In addition, the housing 200 may be provided with the injection hole 240 which serves as a space in which the base material B is injected so that the base material B is injected into the separation space K between the ball 120 and the housing 200 to injection-mold the ball seat 300.

For example, the injection hole 240 may be formed to pass through the bottom portion 230 and may be formed at the center of the bottom portion 230.

In addition, not only the base material B but the lubricant L may be injected into the ball stud 100 and the ball seat 300 which are accommodated in the accommodating space 210 via the injection hole 240.

For example, the housing 200 may be a metal material.

The ball seat 300 may be formed by injecting the base material B into the separation space K via the injection hole 240 to be injection-molded between the ball 120 and the housing 200.

Here, for example, the ball seat 300 may be provided with a contact portion 310 in contact with the ball 120, and an extension portion 320 formed extending from the contact portion 310 and positioned on the injection hole 240.

The extension portion 320 may be formed in contact with the bottom portion 230 of the housing 200, which forms the injection hole 240.

For example, one end of the extension portion 320 may be exposed to the bottom portion 230 of the housing 200.

That is, one end of the extension portion 320 may be exposed to the outside via the injection hole 240.

Since one end of the extension portion 320 is exposed to the outside, a worker may easily remove the ball seat when removing the ball seat 300 from the housing 200.

For example, the injection hole 240 may be closed by the extension portion 320 and the injection hole closing portion 400.

For example, the lubricant L may be stored in a space formed by a dent portion 130, the injection hole closing portion 400, and the extension portion 320.

For example, the length of the extension portion 320 in a vertical direction is greater than the length of the injection hole closing portion 400 in a vertical direction.

Here, the vertical direction may represent a horizontal direction according to FIG. 1.

Accordingly, the injection hole closing portion 400 may be surrounded by the extension portion 320.

For example, the base material B may be a synthetic resin and may be a liquid at a particular temperature.

The ball seat 300 may have a convex and concave shape formed at an outer surface of the contact portion 310 corresponding to a convex and concave shape formed at an inner surface of the side wall portion 220 of the housing 200, thus the ball seat 300 may be solidly coupled to the housing 200 by the correspondence of the convex and concave shapes.

As illustrated in FIGS. 1 and 3, the injection hole closing portion 400 may include a top surface 410 which is first inserted into the injection hole 240, a sloped surface 420 which obliquely extends from the top surface 410, a side surface 430 which obliquely extends from the sloped surface 420, and a bottom surface 440 which is last inserted into the injection hole 240.

Here, a perimeter of the top surface 410 may be less than a perimeter of the bottom surface 440 so that the insertion of injection hole closing portion 400 into the injection hole 240 is guided.

That is, an area of the top surface 410 formed by the circumference of the top surface 410 may be less than an area of the bottom surface 440 formed by the circumference of the bottom surface 440.

Therefore, the injection hole closing portion 400 may include the sloped surface 420 which extends from the top surface 410, and the insertion of the injection hole closing portion 400 into the injection hole 240 is guided and may be easily inserted into the injection hole 240 owing to the sloped surface 420.

In addition, the injection hole closing portion 400 may include an installation portion 450 formed to protrude from the bottom surface 440 or have a dent shape for installing to an external device M which is for inserting the injection hole closing portion 400 into the injection hole 240.

The external device M may exert an external force on the injection hole closing portion 400 so that the injection hole closing portion 400 may be inserted into the injection hole 240.

Here, as illustrated in FIG. 3C, for example, the injection hole closing portion 400 may include the installation portion 450 formed by denting the bottom surface 440 for installing to the external device M.

As the external device M is inserted in the installation portion 450, the injection hole closing portion 400 and the external device M may become connected to each other.

In addition, although not illustrated in the drawings, as another example, the installation portion 450 may be formed protruding from the bottom surface 440, and in this case, the injection hole closing portion 400 and the external device M may become connected to each other as the installation portion 450 is inserted into a hole or a dent portion formed in the external device M.

For example, the injection hole closing portion 400 may be separated from the ball 120 and close the injection hole 240.

Accordingly, friction may not occur on the injection hole closing portion 400 even while the ball 120 performs a pivot movement.

As illustrated in FIGS. 1 and 2, the bottom surface 440 and an entrance E of the injection hole 240 may be positioned at the same level to prevent the injection hole closing portion 400 from being separated from the injection hole 240.

Here, the entrance E of the injection hole 240 may be a virtual plane from which the injection hole closing portion 400 begins to enter into the injection hole 240. That is, the entrance E is positioned to be coplanar with a lower surface of the bottom portion 230 of the housing 200, and the injection hole closing portion 400 may be inserted into the injection hole 240 so that the bottom surface 440 of the injection hole closing portion 400 is positioned to be coplanar with the lower surface of the bottom portion 230.

The bottom surface 440 of the injection hole closing portion 400 may be exposed to the outside.

Therefore, a work may easily remove the injection hole closing portion 400 when replacing the injection hole closing portion 400.

In addition, as illustrated in FIG. 1, the injection hole closing portion 400 may be in contact with the extension portion 320 and inserted into the injection hole 240 to prevent separation from the injection hole 240.

More specifically, the side surface 430 of the injection hole closing portion 400 is in contact with the extension portion 320 when the injection hole closing portion 400 is inserted into the injection hole 240.

Since the extension portion 320 is formed by injection-molding the base material B such as a synthetic resin material, the material thereof may be a synthetic resin and the housing 200 may be a metal material as described above.

Here, for example, the injection hole closing portion 400 may be a synthetic resin, and when properties of the materials are considered, a frictional coefficient between the injection hole closing portion 400 and the extension portion 320 may be greater than a frictional coefficient between the injection hole closing portion 400 and the housing 200.

Accordingly, since the injection hole closing portion 400 is in contact with the extension portion 320 and inserted into the injection hole 240, separation of the injection hole closing portion 400 from the injection hole 240 may be further prevented.

In addition, since the extension portion 320 may be a synthetic resin having elasticity while the housing 200 is an inelastic metal material, the separation of the injection hole closing portion 400 from the injection hole 240 may be further prevented due to an elastic force of the extension portion 320 when the injection hole closing portion 400 is in contact with the extension portion 320 and inserted into the injection hole 240.

In addition, for example, the injection hole closing portion 400 may be pressed and inserted into the injection hole 240 so that the lubricant L stored in the dent portion 130 may move between the ball 120 and the ball seat 300. Here, the dent portion 130 is formed in the ball 120, which will be further described below in detail.

That is, since the injection hole closing portion 400 is in contact with the extension portion 320 of the ball seat 300 and pressed and inserted into the injection hole 240, by the pressure thereof, the lubricant L injected into the ball 120 via the injection hole 240 may move in the space between the ball 120 and the ball seat 300.

As a result, lubrication between the ball 120 and the ball seat 300 may be further improved.

As illustrated in FIGS. 1 and 4, the ball 120 may be provided with the dent portion 130 formed by denting the surface to store the lubricant L which mitigates surface pressure between the ball 120 and the ball seat 300.

In addition, the dent portion 130 is formed to face the injection hole 240 to store the lubricant L injected via the injection hole 240.

That is, the lubricant L may be injected into the housing 200 via the injection hole 240, and the injected lubricant L may be stored in the dent portion 130 of the ball 120.

Accordingly, the lubrication between the ball 120 and the ball seat 300 may be further improved.

For example, the dent portion 130 may have a shape having a narrower upper portion and a wider lower portion to store the lubricant L.

That is, the dent portion 130 may have a shape having a narrower upper portion and a wider lower portion and may be a circular cone shape schematically.

In addition, the dent portion 130 is formed in the ball 120 so that the central axis of the dent portion 130 in a vertical direction is aligned with the central axis of the ball stud 100 in a vertical direction.

However, the shape of the dent portion 130 is not limited to the shape illustrated in the drawings, and it should be obvious that various modifications may be made as long as it may store the lubricant L from the view point of those skilled in the art.

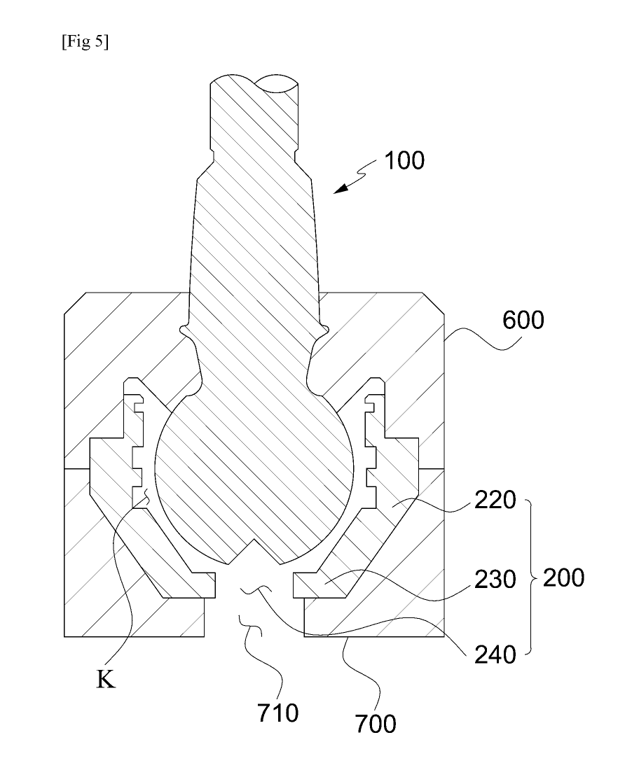

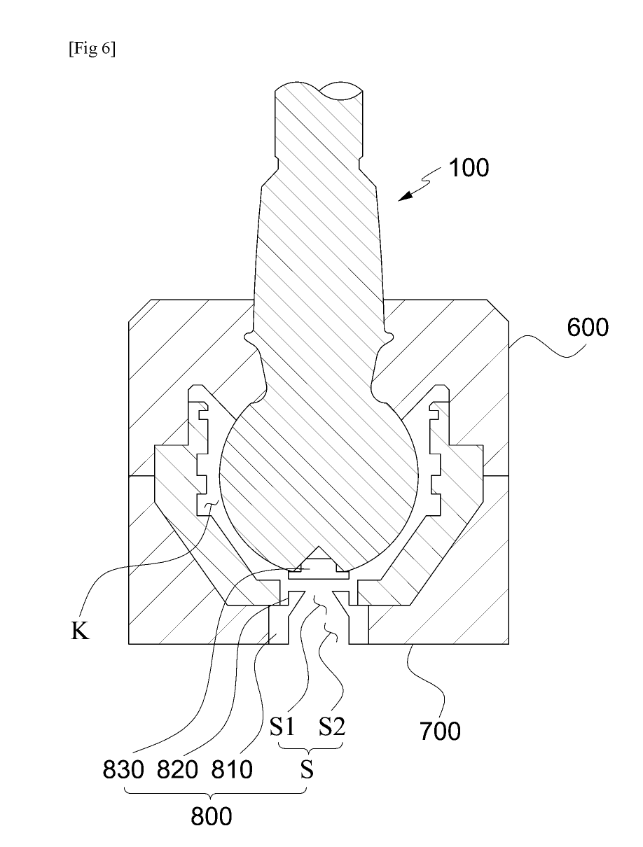

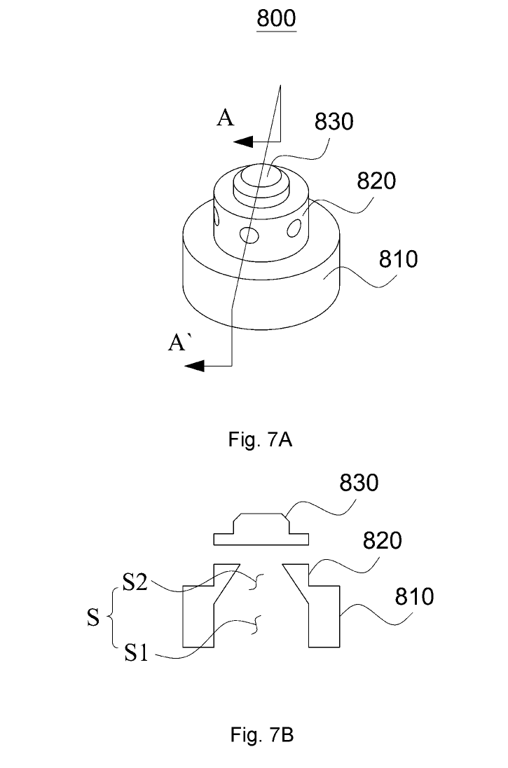

FIGS. 5 and 6 are schematic cross-sectional views illustrating an apparatus for manufacturing the ball joint according to one embodiment of the present invention, and FIGS. 7A and 7B are a schematic perspective view and a schematic cross-sectional view illustrating an insertion portion 800 of the apparatus for manufacturing the ball joint according to one embodiment of the present invention.

As illustrated in FIGS. 5 to 7, an apparatus for manufacturing the ball joint 10 used in a steering system according to one embodiment of the present invention may include an upper mold 600, a lower mold 700 which provides a space in which the housing 200 that accommodates the ball stud 100 is disposed by being coupled to the upper mold 600 and includes a base material injection portion 710 formed to pass therethrough so that the base material B for forming the ball seat 300 is injected into the separation space K between the ball stud 100 and the housing 200, and an insertion portion 800 inserted into the base material injection portion 710 and including an injection space S which provides an injection channel of the base material B so that the base material B is uniformly injected into the entire separation space K.

In the drawings, the upper mold 600 and the lower mold 700 are vertically illustrated as being opened and closed in a vertical direction, but it is not limited thereto. Although not illustrated in the drawings, the molds may be laterally formed to be opened and closed in a lateral direction.

Referring to FIGS. 5 to 7, the insertion portion 800 may further include an inflow prevention portion 830 inserted into the dent portion 130 formed by denting the surface of the ball 120 to prevent the base material B from being introduced into the dent portion 130 so that the lubricant L is stored in the ball stud 100.

That is, as described above, the ball 120 may include the dent portion 130 to store the lubricant L injected via the injection hole 240, and the inflow prevention portion 830 inserted into the dent portion 130 may prevent the base material B from being introduced into the dent portion 130 because the base material B should not be introduced into the dent portion 130 where the lubricant L should be stored when the base material B is injected into the separation space K via the injection hole 240 to injection-mold the ball seat 300.

In addition, the inflow prevention portion 830 may determine an insertion position of the insertion portion 800 in a lateral direction since the inflow prevention portion 830 is in contact with the ball 120 which forms the dent portion 130 and inserted into the dent portion 130.

For example, by the inflow prevention portion 830, the insertion portion 800 may, be inserted and positioned at the dent portion 130 so that the central axis of the insertion portion 800 in a vertical direction is aligned with the central axis of the ball stud 100 in a vertical direction.

FIG. 7A is a schematic perspective view illustrating the insertion portion 800, and the FIG. 7B is a schematic cross-sectional view taken along line A-A′ of FIG. 7A. As illustrated in FIGS. 7A and 7B, the insertion portion 800 may further include an injection portion 810 which forms an injection space S into which the base material B is injected from the outside and an injection extension portion 820 formed to extend from the injection portion 810 and forms an injection space S.

That is, for example, the insertion portion 800 may include the injection portion 810, the injection extension portion 820, and the inflow prevention portion 830 formed extending from the injection extension portion 820 in an upward direction.

Here, as illustrated in FIG. 6, the injection extension portion 820 may have a width smaller than that of the injection hole 240 so that the ball seat 300 is formed on the injection hole 240.

That is, the injection extension portion 820 may have a width smaller than that of the injection hole 240 so that the base material B is injected between the bottom portion 230 of the housing 200 which forms the injection hole 240 and the injection extension portion 820 to form the extension portion 320 of the ball seat 300.

In addition, the injection space S may include an introduction space S2 which provides a space for the base material B to be injected from the outside and a backflow prevention space Si formed to have a size smaller than the introduction space S2 so that the base material B injected into the separation space K between the ball stud 100 and the housing 200 does not flow backward.

The base material B is injected into the separation space K from the outside via the injection space S, and since the base material injected into the separation space K may flow backward due to gravity, the base material B injected into the separation space K may be prevented from flowing backward by forming the backflow prevention space S1.

In addition, for example, although not illustrated in the drawings, a device that injects the base material B may be inserted into the introduction space S2 and the width of the device injecting the base material B may be the same as the width of the introduction space S2.

Here, the depth of the device injecting the base material B inserted into the introduction space S2 may be constrained by the backflow prevention space S1. That is, the device injecting the base material B is inserted in the introduction space S2 in an upward direction, but the device injecting the base material B may not be inserted any more in the injection space S in an upward direction when the device injecting the base material B comes into contact with the insertion portion 800 which forms the backflow prevention space S1.

Therefore, the backflow prevention space S1 may limit the depth into the injection space S to which the device injecting the base material B is inserted.

FIGS. 5, 6, and 8 to 10 are schematic cross-sectional views sequentially illustrating a method of manufacturing the ball joint according to one embodiment of the present invention.

As illustrated in FIG. 5, a method of manufacturing the ball joint which injection-molds the ball seat 300 in the separation space K between the ball stud 100 and the housing 200 may include a first operation in which the ball stud 100 and the housing 200 are disposed at predetermined positions of the upper mold 600 and the lower mold 700.

As illustrated as above, the lower mold 700 may include the base material injection portion 710 formed to pass through the lower mold 700 so that the base material B is injected into the separation space K.

After disposing the ball stud 100 and the housing 200 at the predetermined positions of the upper mold 600 and the lower mold 700 in the first operation, as illustrated in FIG. 6, the method of manufacturing the ball joint 10 according to one embodiment of the present invention may include a second operation in which the insertion portion 800 which provides a channel through which the base material B is injected is disposed at the housing 200 so that the ball seat 300 is injection-molded in the separation space K between the ball stud 100 and the housing 200.

That is, the insertion portion 800 may be formed at a predetermined position while being simultaneously inserted into the base material injection portion 710 of the lower mold 700 and into the injection hole 240 of the housing 200.

Here, as described above, the insertion portion 800 may, by the inflow prevention portion 830, be positioned on the injection hole 240 so that the central axis of the insertion portion 800 in a vertical direction is aligned with the central axis of the ball stud 100 in a vertical direction.

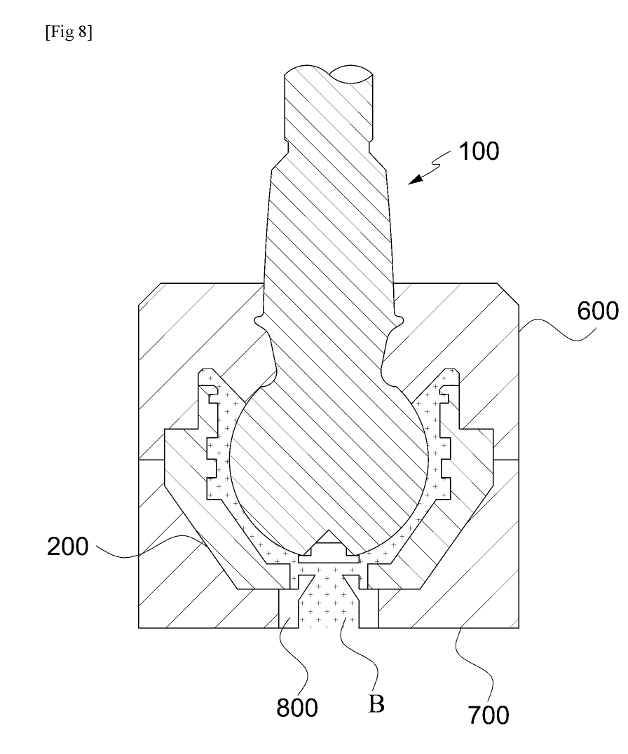

After disposing the insertion portion 800 at a predetermined position of the housing 200 in the second operation, as illustrated in FIG. 8, the method of manufacturing the ball joint according to one embodiment of the present invention may include a third operation in which the base material B is injected into the separation space K via the insertion portion 800.

As described above, the insertion portion 800 may include the inflow prevention portion 830 inserted in the dent portion 130 formed by denting the surface of the ball 120 to prevent the base material B from being introduced into the dent portion 130.

Accordingly, the base material B may not be introduced into the dent portion 130.

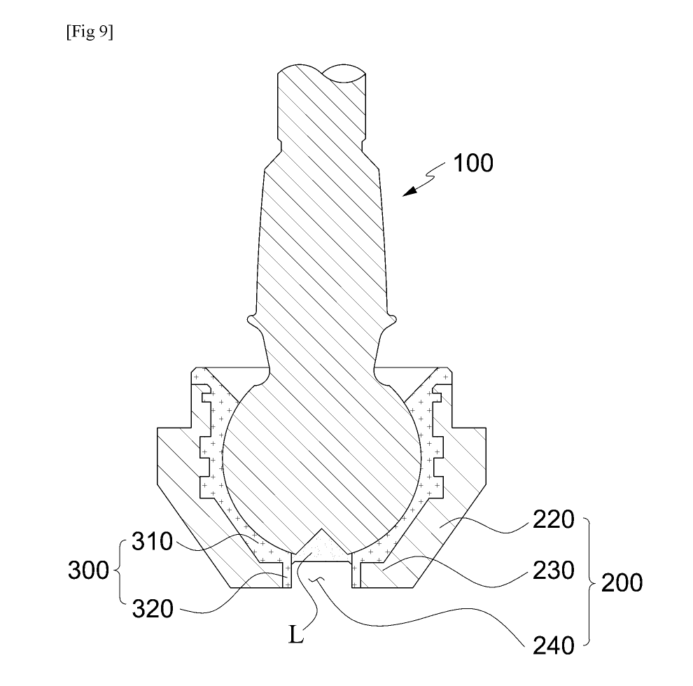

After injecting the base material B into the separation space K in the third operation, the base material B may be coagulated for a preset time to a preset strength, and after having the preset strength, as illustrated in FIG. 9, the method of manufacturing the ball joint according to one embodiment of the present invention may include a fourth operation in which the insertion portion 800 is removed from the injection hole 240 and the lubricant L is injected into the space in which the insertion portion 800 is removed.

The lubricant L may be injected via the injection hole 240 and stored in the dent portion 130 of the ball 120.

Although the injection hole 240 is illustrated to be positioned at the bottom part in FIG. 9, the injection hole 240 may be positioned at the top part when the lubricant L is injected into the dent portion 130 to store the lubricant L in the dent portion 130 using gravity.

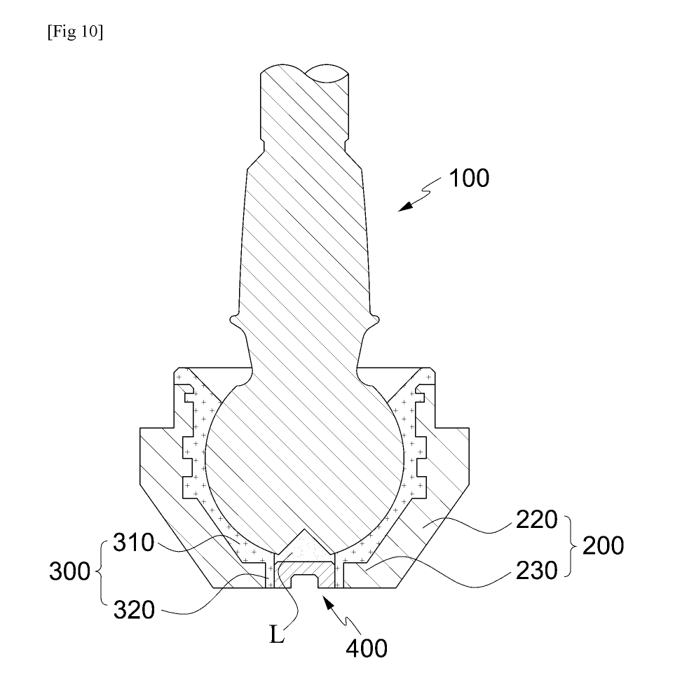

After injecting the lubricant L into the dent portion 130 in the fourth operation, as illustrated in FIG. 10, the method of manufacturing the ball joint according to one embodiment of the present invention may include a fifth operation in which the injection hole closing portion 400 is pressed and inserted into the space in which the insertion portion 800 is removed so that the lubricant L stored in the dent portion 130 moves between the ball 120 and the ball seat 300.

Accordingly, the lubricant L moves between the ball 120 and the ball seat 300, and as a result, the lubrication between the ball 120 and the ball seat 300 may be further improved.

As described above, the ball joint, the apparatus for manufacturing the ball joint, and the method of manufacturing the ball joint according to the embodiments of the present invention can effectively close the injection hole provided in the housing to integrally injection-mold the ball seat, mitigates the surface pressure between the ball and ball seat, improves the lubrication effect between the ball and the ball seat, and thereby can provide a ball joint having excellent durability, the apparatus for manufacturing the ball joint, and the method of manufacturing the ball joint.

The configuration and features of the present invention are described as above based on the embodiments according to the present invention, but the present invention is not limited thereto, and it should be obvious to those skilled in the art of the technical field to which the present invention belongs that various modifications and transformations may be made within the sprit and scope of the present invention, therefore it should be noted that such modifications and transformations belong to the scope of the claims below.

### REFERENCE NUMERALS

| | |
|---|---|
| 100: BALL STUD | 200: HOUSING |
| 300: BALL SEAT | 400: INJECTION HOLE CLOSING PORTION |
| 500: DUST COVER | |

What is claimed is:

1. A ball joint used in a steering system, comprising;
a ball stud including a stud and a ball formed at one end of the stud;
a housing which accommodates the ball to pivotally support the ball stud and includes an injection hole into which a lubricant and a base material are injectable;
a ball seat formed in a separation space between the ball and the housing; and
an injection hole closing portion inserted into the injection hole to close the injection hole,
wherein the ball includes a dent portion formed by denting the surface to store the lubricant and to mitigate surface pressure between the ball and the ball seat.

2. The ball joint of claim 1, wherein the injection hole closing portion has a perimeter of a top surface, which is first inserted into the injection hole to guide the insertion into the injection hole, smaller than a perimeter of a bottom surface.

3. The ball joint of claim 1, wherein the injection hole closing portion includes an installation portion, on which an external device is installable, at a bottom surface which is last inserted into the injection hole so that the external device for inserting the injection hole closing portion into the injection hole is installed.

4. The ball joint of claim 1, wherein the injection hole closing portion has a bottom surface which is last inserted into the injection hole is positioned at the same level as an entrance of the injection hole to prevent the injection hole closing portion from being separated from the injection hole.

5. The ball joint of claim 1, wherein:
the ball seat includes a contact portion in contact with the ball, and an extension portion formed to extend from the contact portion and positioned on the injection hole; and
the injection hole closing portion is in contact with the extension portion and inserted into the injection hole to prevent being separated from the injection hole.

6. The ball joint of claim 1, wherein the injection hole closing portion is pressed and inserted into the injection hole so that the lubricant stored in the dent portion moves between the ball and the ball seat.

7. The ball joint of claim 1, wherein the dent portion is formed to face the injection hole to store the lubricant injected via the injection hole.

8. The ball joint of claim 1, wherein the dent portion has a shape having a narrower upper portion and a wider lower portion to store the lubricant injected via the injection hole.

9. The ball joint of claim 1, wherein the ball seat includes:
a contact portion in contact with the ball; and
an extension portion formed to extend from the contact portion and positioned on the injection hole,
wherein the extension portion has one end exposed to the outside.

10. The ball joint of claim 1, wherein the ball seat includes:
a contact portion in contact with the ball; and
an extension portion formed to extend from the contact portion and positioned on the injection hole,
wherein one end of the extension portion and one surface of the injection hole closing portion are exposed to the outside.

11. The ball joint of claim 1, wherein:
the ball seat includes a contact portion in contact with the ball and an extension portion formed to extend from the contact portion and positioned on the injection hole; and
the injection hole is closed by the extension portion and the injection hole closing portion.

12. The ball joint of claim 1, wherein:
the ball seat includes a contact portion in contact with the ball and an extension portion formed to extend from the contact portion and positioned on the injection hole; and
the lubricant is stored in a space formed by the dent portion, the injection hole closing portion, and the extension portion.

13. The ball joint of claim 1, wherein:
the ball seat includes a contact portion in contact with the ball and an extension portion formed to extend from the contact portion and positioned on the injection hole; and
a length of the extension portion in a vertical direction is greater than a length of the injection hole closing portion in a vertical direction.

14. The ball joint of claim 1, wherein the injection hole closing portion is separated from the ball and closes the injection hole.

15. A ball joint manufacturing apparatus for manufacturing a ball joint used in a steering system, the apparatus comprising:
an upper mold;
a lower mold which provides a space in which a housing that accommodates a ball stud is disposed by being coupled to the upper mold and includes a base material injection portion formed to pass therethrough so that a base material for forming a ball seat is injected into a separation space between the ball stud and the housing; and
an insertion portion inserted into the base material injection portion and including an injection space which provides an injection channel of the base material so that the base material is uniformly injected into the entire separation space,
wherein the insertion portion further includes an inflow prevention portion inserted into a dent portion formed by denting the surface of the ball to prevent the base material from being introduced into the dent portion so that the lubricant is stored in the ball stud.

16. The apparatus of claim 15, wherein the insertion portion further includes:
an injection portion which forms the injection space into which the base material is injected from the outside; and
an injection extension portion formed to extend from the injection portion and configured to form the injection space,
wherein the injection extension portion has a width smaller than a width of an injection hole to form a ball seat on the injection hole formed to pass through the housing for the base material to be injected into the separation space between the ball stud and the housing.

17. The apparatus of claim 15, wherein the injection space includes:
an introduction space which provides a space for the base material to be injected from the outside; and
a backflow prevention space formed to have a size smaller than the introduction space to prevent the base material injected into the separation space between the ball stud and the housing from flowing backward.

18. A method of manufacturing a ball joint by injection-molding a ball seat between a ball stud including a ball and a housing, the method comprising:
a first operation in which the ball stud and the housing are disposed at predetermined positions of an upper mold and a lower mold;
a second operation in which an insertion portion which provides a channel through which a base material is injected is disposed in the housing so that the ball seat is injection-molded in the separation space between the ball stud and the housing;
a third operation in which the base material is injected into the separation space via the insertion portion;
a fourth operation in which the insertion portion is removed and a lubricant is injected into the space in which the insertion portion is removed; and
a fifth operation in which an injection hole closing portion is pressed and inserted into the space in which the insertion portion is removed so that the lubricant moves between the ball and the ball seat.

19. The method of claim 18, wherein the third operation includes injecting the base material into the separation space via the insertion portion which includes an inflow prevention portion inserted into a dent portion and preventing the base material from being introduced into the dent portion, wherein the dent portion is formed by denting the surface of the ball.

20. The method of claim 18, wherein the fourth operation includes injecting the lubricant into a dent portion formed by denting the surface of the ball.
